(19) United States
(12) Patent Application Publication
(10) Pub. No.: US 2025/0137401 A1
(43) Pub. Date: May 1, 2025

(54) ENGINE

(71) Applicant: SUZUKI MOTOR CORPORATION, Hamamatsu-shi (JP)

(72) Inventors: Shinichi YAMADA, Hamamatsu-shi (JP); Yoshikatsu AKITA, Hamamatsu-shi (JP)

(73) Assignee: SUZUKI MOTOR CORPORATION, Hamamatsu-shi (JP)

(21) Appl. No.: 18/818,038

(22) Filed: Aug. 28, 2024

(30) Foreign Application Priority Data
Oct. 26, 2023 (JP) 2023-183738

(51) Int. Cl. F02B 61/02; F01N 13/08

(52) U.S. Cl. CPC F02B 61/02; F01N 13/08; F01N 2340/04

(57) ABSTRACT

An engine to be mounted on a straddle-type vehicle. The engine includes a cylinder and a cylinder head stacked on an upper portion of a crank case, an exhaust pipe extending from the cylinder head and passing through a lateral side of the cylinder, an exhaust gas sensor attached to the exhaust pipe, on the lateral side of the cylinder, and a radiator positioned in front of the cylinder head. The exhaust gas sensor is covered by the radiator from a front side.

### CROSS-REFERENCE TO RELATED APPLICATIONS

This application is based on and claims priority under 35 USC 119 from Japanese Patent Application No. 2023-183738 filed on Oct. 26, 2023, the entire content of which is incorporated herein by reference.

### TECHNICAL FIELD

The present disclosure relates to an engine.

### BACKGROUND ART

As an engine for a straddle-type vehicle, there is an engine in which an exhaust pipe passes through a lateral side of a cylinder (see, for example, JP3489242B). In the engine described in JP3489242B, the cylinder is disposed on a crank case, and a cylinder head is disposed on the cylinder. An exhaust port is formed in a front surface of the cylinder head, and the exhaust pipe extends downward from the exhaust port toward the crank case. The exhaust pipe curves upward in front of the crank case and extends to the cylinder, and the exhaust pipe passes through the lateral side of the cylinder and extends to a rear side of the vehicle. The exhaust pipe passes through the lateral side of the cylinder, so that a minimum ground clearance of the straddle-type vehicle is ensured.

Incidentally, an exhaust gas sensor is attached to the exhaust pipe, but depending on a position where the exhaust gas sensor is disposed, the exhaust gas sensor may be exposed to the outside, increasing a risk of damage.

### SUMMARY OF INVENTION

Aspect of non-limiting embodiments of the present disclosure relates to provide an engine capable of reducing the risk of damage to the exhaust gas sensor in a model in which the exhaust pipe passes through the lateral side of the cylinder.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an engine to be mounted on a straddle-type vehicle, the engine including:
a cylinder and a cylinder head stacked on an upper portion of a crank case;
an exhaust pipe extending from the cylinder head and passing through a lateral side of the cylinder;
an exhaust gas sensor attached to the exhaust pipe, on the lateral side of the cylinder; and
a radiator positioned in front of the cylinder head,
wherein the exhaust gas sensor is covered by the radiator from a front side.

### BRIEF DESCRIPTION OF DRAWINGS

Exemplary embodiment(s) of the present invention will be described in detail based on the following figures, wherein:

FIG. 1 is a right side view of a straddle-type vehicle according to an embodiment;

FIG. 2 is a right side view of a periphery of an engine according to the present embodiment;

FIG. 3 is a front view of the periphery of the engine according to the present embodiment;

FIG. 4 is a perspective view of the periphery of the engine according to the present embodiment when obliquely viewed from a rear and right side;

FIG. 5 is a front view of a periphery of a second oxygen sensor according to the present embodiment; and

FIG. 6 is a right side view of the periphery of the second oxygen sensor according to the present embodiment.

### DESCRIPTION OF EMBODIMENTS

An engine according to one aspect of the present disclosure is mounted on a straddle-type vehicle, in which a cylinder and a cylinder head are stacked on an upper portion of a crank case. An exhaust pipe extends from the cylinder head through a lateral side of the cylinder, and an exhaust gas sensor is attached to the exhaust pipe on the lateral side of the cylinder. A radiator is positioned in front of the cylinder head, and the exhaust gas sensor is covered by the radiator from a front side. The exhaust gas sensor is attached to the exhaust pipe on the lateral side of the cylinder, so as to ensure the minimum ground clearance of the straddle-type vehicle. Even in a case where the exhaust gas sensor is attached to the exhaust pipe, the exhaust gas sensor is covered from the front side by the radiator, so that the exhaust gas sensor is protected by the radiator, thereby reducing the risk of damage thereto.

### Embodiment

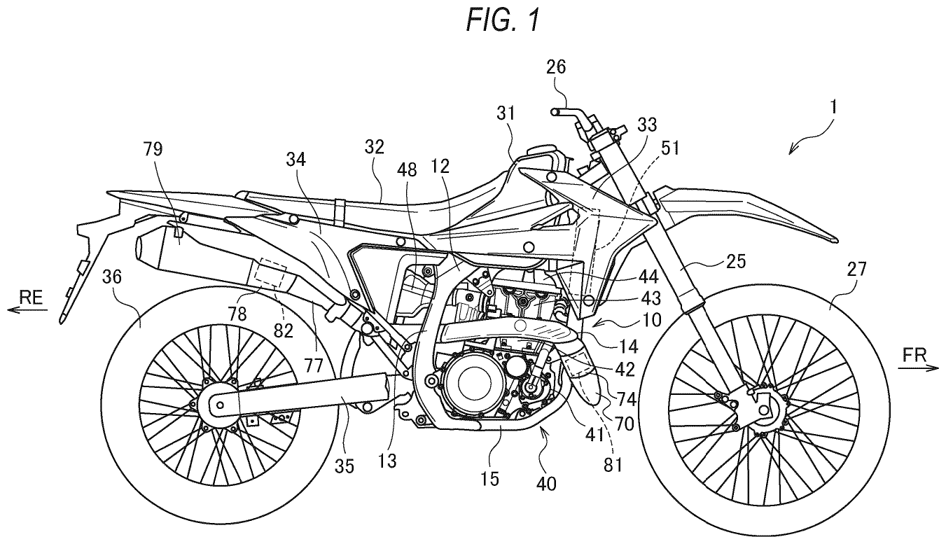

Hereinafter, a straddle-type vehicle according to the present embodiment will be described with reference to the accompanying drawings. FIG. 1 is a right side view of the straddle-type vehicle according to the present embodiment. In the following drawings, an arrow FR indicates a vehicle front side, an arrow RE indicates a vehicle rear side, an arrow L indicates a vehicle left side, and an arrow R indicates a vehicle right side.

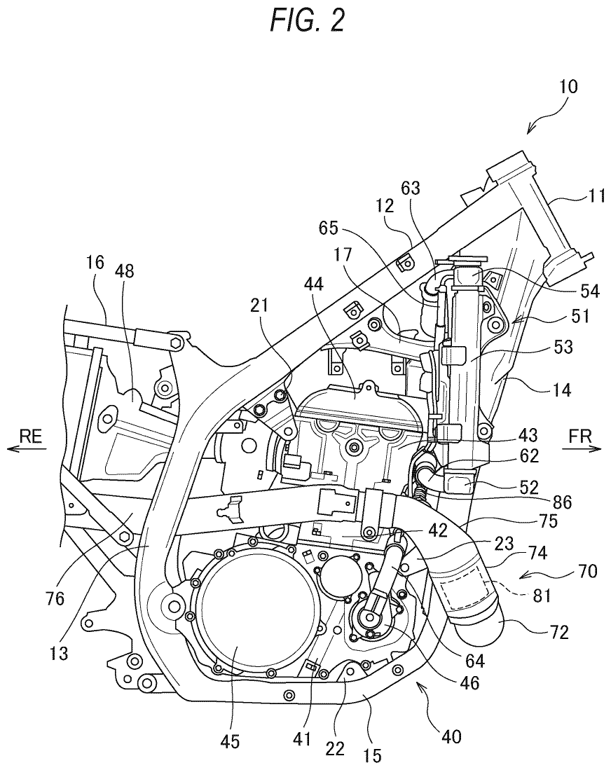

As shown in FIG. 1, a straddle-type vehicle 1 is implemented by mounting various components such as an engine 40 and an electrical system on a vehicle frame 10. A pair of main frames 12 extend obliquely rearward and downward from a head pipe 11 (see FIG. 2) of the vehicle frame 10. Rear portions of the pair of main frames 12 form a pair of body frames 13 bent downward. A down frame 14 extends downward from the head pipe 11. An under loop 15 bent rearward is connected to a lower portion of the down frame 14. Rear ends of the pair of under loops 15 are connected to lower portions of the pair of body frames 13, so that the vehicle frame 10 is formed into a cradle shape.

A front fork 25 is steerably supported by the head pipe 11 via a steering shaft (not shown). A handle 26 is provided at an upper portion of the front fork 25. A front wheel 27 is rotatably supported by a lower portion of the front fork 25. A fuel tank 31 is placed over upper portions of the pair of main frames 12. The main frames 12 and the fuel tank 31 are covered by a front side cover 33 from a lateral side. A seat 32 is disposed behind the fuel tank 31. A seat frame 16 (see FIG. 2) that supports the seat 32 from below is covered by a rear side cover 34 from a lateral side.

A swing arm 35 is swingably supported on the body frame 13. The swing arm 35 extends rearward from the body frame 13. A rear wheel 36 is rotatably supported at a rear end of the swing arm 35. The engine 40 is a four-stroke single-cylinder engine. The engine 40 is suspended inside the vehicle frame 10 via a plurality of suspension brackets. A cylinder assembly in which a cylinder 42, a cylinder head 43, and a cylinder head cover 44 are stacked is attached to an upper portion of a crank case 41 of the engine 40. At a rear side of the cylinder head 43, an air cleaner 48 is disposed.

Left and right radiators 51, 55 are positioned in front of the cylinder head 43. The left and right radiators 51, 55 are attached to the down frame 14. Only the right radiator 51 is shown in FIG. 1. An exhaust pipe 70 extends downward from a left side of a front surface of the cylinder head 43. The exhaust pipe 70 passes through a right lateral side of the cylinder 42 and is connected to a muffler 79 at a rear side of the vehicle. A primary catalyst case 74 is formed in the exhaust pipe 70 in front of the crank case 41. A secondary catalyst case 78 is formed in the exhaust pipe 70 behind the air cleaner 48. The primary catalyst case 74 accommodates a primary catalyst 81. The secondary catalyst case 78 accommodates a secondary catalyst 82.

In a case where the primary catalyst case 74 is provided in front of the crank case 41, it is difficult to provide an oxygen sensor on an upstream side or a downstream side of the primary catalyst case 74. Especially, in the straddle-type vehicle 1 of the present embodiment, in order to ensure the minimum ground clearance, the exhaust pipe 70 on the downstream side of the primary catalyst case 74 passes through the lateral side of the cylinder 42 and extends rearward. Since the exhaust pipe 70 is exposed at the lateral side of the cylinder 42, if an oxygen sensor is provided in this positioned, there is a high risk of damage. Therefore, in the present embodiment, the risk of damage is reduced by covering the oxygen sensor with a peripheral component such as the radiator, or by adjusting an attachment direction of the oxygen sensor.

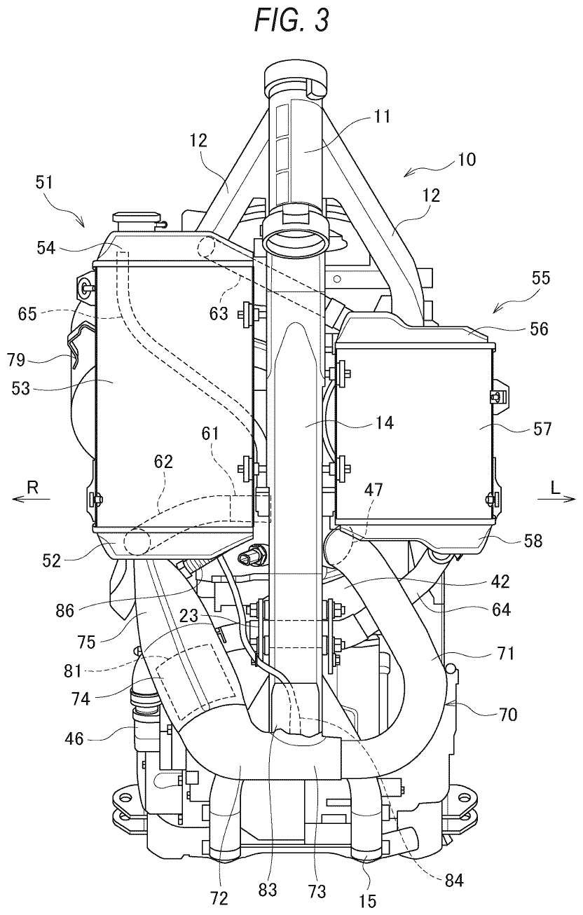

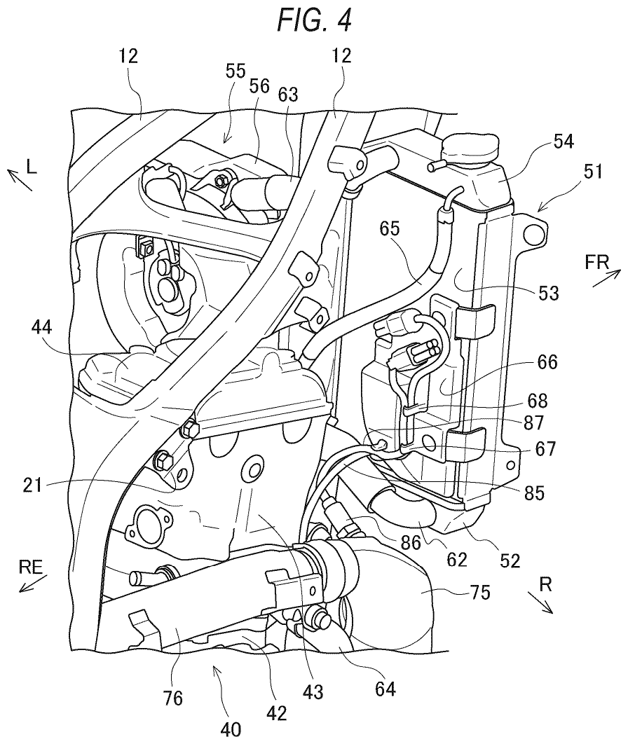

Peripheral structures of the engine will now be described with reference to FIG. 2 to 4. FIG. 2 is a right side view of a periphery of the engine according to the present embodiment. FIG. 3 is a front view of the periphery of the engine according to the present embodiment. FIG. 4 is a perspective view of the periphery of the engine according to the present embodiment when obliquely viewed from a rear and right side.

As shown in FIG. 2, the pair of main frames 12 and the down frame 14 are connected to each other via bridge tubes 17 for reinforcement, at an upper portion of the vehicle frame 10. Below the bridge tubes 17, the engine 40 is suspended from the vehicle frame 10 by suspension brackets 21 to 23. A clutch cover 45 is attached to a right side surface of the crank case 41 of the engine 40. A water pump 46 is provided in front of the clutch cover 45. A discharge port of the water pump 46 is connected to a cooling passage in the crank case 41. A cooling water is delivered from the water pump 46 to the inside of the cylinder 42 and to a water jacket in the cylinder head 43.

As shown in FIGS. 2 and 3, the right radiator 51 and the left radiator 55 are provided in front of the cylinder head 43 with the down frame 14 at a center of the vehicle interposed therebetween. The right radiator 51 is formed to be larger than the left radiator 55. In the right radiator 51, a right inlet tank (the lower tank) 52 is provided below a right radiator core 53, and a right outlet tank 54 is provided above the right radiator core 53. In the left radiator 55, a left inlet tank 56 is provided above a left radiator core 57, and a left outlet tank 58 is provided below the left radiator core 57.

A thermostat cover 61 is provided on a front surface of the engine 40, and a thermostat (not shown) is provided inside the thermostat cover 61. The right inlet tank 52 is connected to the thermostat cover 61 via an inlet hose (hose) 62. The right outlet tank 54 and the left inlet tank 56 are connected to each other via an inter-radiator hose 63. The left outlet tank 58 is connected to the water pump 46 via an outlet hose 64. An upper portion of the thermostat cover 61 is connected to the right outlet tank 54 via an air vent hose 65.

In the right radiator 51, the cooling water flows upward from the right inlet tank 52 toward the right outlet tank 54, and while the cooling water passes through the right radiator core 53, the heat of the cooling water is radiated into the air. The cooling water is sent from the right outlet tank 54 to the left inlet tank 56 through the inter-radiator hose 63. In the left radiator 55, the cooling water flows downward from the left inlet tank 56 toward the left outlet tank 58, and while the cooling water passes through the left radiator core 57, the heat of the cooling water is radiated into the air. The heat of the cooling water is radiated in two stages by the right radiator 51 and the left radiator 55, so that cooling efficiency is improved.

The cylinder head 43 and an intermediate portion of the outlet hose 64 are connected via a bypass hose (not shown). A bypass passage is formed by the bypass hose, which bypasses the right radiator 51 and the left radiator 55 and returns the cooling water from the cylinder head 43 (upstream of the thermostat) to the water pump 46. In a case where a temperature of the cooling water is lower than a predetermined temperature, the thermostat closes and the cooling water is returned from the cylinder head 43 through the bypass hose to the water pump 46. In a case where the temperature of the cooling water is equal to or higher than the predetermined temperature, the thermostat opens, and the cooling water flows into the right radiator 51 and the left radiator 55 to cool the engine 40.

An exhaust port 47 obliquely facing a left and lower side is formed in the front surface of the cylinder head 43. The exhaust pipe 70 is connected to the exhaust port 47. The exhaust pipe 70 extends downward from the exhaust port 47 passing through the left lateral side of the down frame 14, crosses a front side of the down frame 14, and then extends upward passing through the right lateral side of the down frame 14. The exhaust pipe 70 is curved into a U-shape using a space in front of the vehicle body, so that a radius of curvature of a curved portion of the exhaust pipe 70 becomes large, and exhaust resistance is reduced. The exhaust pipe 70 extends rearward passing through the right lateral side of the cylinder 42. A rear end of the exhaust pipe 70 is connected to the muffler 79 near the seat 32.

The exhaust pipe 70 is formed by connecting an upstream pipe 71, a diameter-enlarged pipe 72, the primary catalyst case 74, a diameter-reduced pipe 75, a downstream pipe 76, a diameter-enlarged pipe 77 (see FIG. 1), and the secondary catalyst case 78 (see FIG. 1). The upstream pipe 71 obliquely extends to a left and lower side from the exhaust port 47 and then is curved to toward the right side. The diameter-enlarged pipe 72 extends rightward from a downstream end of the upstream pipe 71, crosses the front side of the down frame 14, and then is obliquely curved to an upper and right side. A front half of the diameter-enlarged pipe 72 that crosses the down frame 14 is a straight portion 73 having a straight pipe shape. A rear half of the diameter-enlarged pipe 72 is curved while being enlarged in diameter from the straight portion 73 toward the downstream side.

A guard member 83 protrudes upward from the straight portion 73 of the diameter-enlarged pipe 72. A first oxygen sensor 84 is attached to an upper surface of the straight portion 73 behind the guard member 83 in a front view. The first oxygen sensor 84 is positioned in front of the down frame 14. The first oxygen sensor 84 is sandwiched between the down frame 14 and the guard member 83 from the front and rear sides. The first oxygen sensor 84 is protected by the guard member 83 and the down frame 14. By attaching the first oxygen sensor 84 to the straight portion 73, deviation of the flow of the exhaust gas in the vicinity of a detection end of the first oxygen sensor 84 is reduced, thereby improving detection accuracy.

The primary catalyst case (accommodation portion) 74 and the diameter-reduced pipe (diameter-reduced portion) 75 are integrally formed. The primary catalyst case 74 obliquely extends to an upper and right side from a downstream end of the diameter-enlarged pipe 72. The diameter-reduced pipe 75 is curved rearward from a downstream end of the primary catalyst case 74. The primary catalyst case 74 is formed to have a larger diameter than the upstream pipe 71. The primary catalyst 81 is accommodated inside the primary catalyst case 74. Air pollutants in the exhaust gas are purified as the exhaust gas passes through the primary catalyst 81. The diameter-reduced pipe 75 is curved while reducing in diameter from the primary catalyst case 74 toward the downstream.

The downstream side of the diameter-reduced pipe 75 is positioned on the lateral side of the cylinder 42. A second oxygen sensor (exhaust gas sensor) 86 is attached to the diameter-reduced pipe 75 on the lateral side of the cylinder 42. A base end of the second oxygen sensor 86 faces inward in the vehicle width direction. A base end of the second oxygen sensor 86 is positioned in a space surrounded by the peripheral components such as the right radiator 51, the cylinder head 43, the inlet hose 62, and the diameter-reduced pipe 75. The second oxygen sensor 86 is protected by the peripheral components. The second oxygen sensor 86 is positioned at a downstream side of the diameter-reduced pipe 75 where the diameter is reduced. Even in a case where the diameter-reduced pipe 75 is curved, the exhaust gas is not likely to hit a detection end of the second oxygen sensor 86, so that the detection accuracy will not be impaired.

The downstream pipe 76 extends rearward from the downstream end of the diameter-reduced pipe 75 passing through the right lateral side of the cylinder 42. The diameter-enlarged pipe 77 is enlarged in diameter from the downstream end of the downstream pipe 76 toward the rear side. The secondary catalyst case 78 is formed to have a larger diameter than the downstream pipe 76. The secondary catalyst 82 (see FIG. 1) is accommodated inside the secondary catalyst case 78. Air pollutants in the exhaust gas are purified as the exhaust gas passes through the secondary catalyst 82. The muffler 79 is connected to the downstream end of the secondary catalyst case 78. Exhaust gas that passes through the secondary catalyst 82 is discharged from the muffler 79 to the outside.

The diameter-enlarged pipe 72 is formed in a hollow structure constituted by front and rear pipe halves. The primary catalyst case 74 and the diameter-reduced pipe 75 are also formed in a hollow structure constituted by left and right pipe halves. Therefore, mounting bosses for the first and second oxygen sensors 84, 86 can be easily provided on each of the pipe halves. The first oxygen sensor 84 detects an oxygen concentration in the exhaust gas, and the second oxygen sensor 86 detects an oxygen concentration in the exhaust gas that passes through the primary catalyst 81. A detection result of the first oxygen sensor 84 is used for feedback control of a fuel injection amount. A detection result of the second oxygen sensor 86 is used for diagnosing catalyst deterioration.

As shown in FIG. 4, a first lead wire 85 extends upward from a base end of the first oxygen sensor 84 (see FIG. 2). A second lead wire 87 extends upward from the base end of the second oxygen sensor 86. The right radiator 51 is provided with a shroud 66 that covers the right radiator core 53. The shroud 66 is provided with cable holders 67, 68. The first lead wire 85 is held by the suspension bracket 23 (see FIG. 3) of the down frame 14 and then extends toward the second oxygen sensor 86 and is held together with the first lead wire 85 by the cable holders 67, 68 of the shroud 66. By reducing vibration of the first and second lead wires 85, 87, damage to the first and second lead wires 85, 87 is prevented.

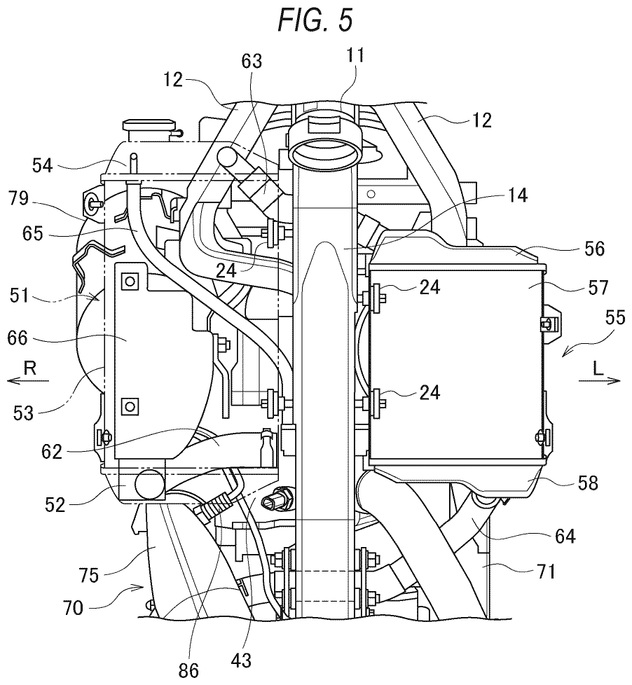

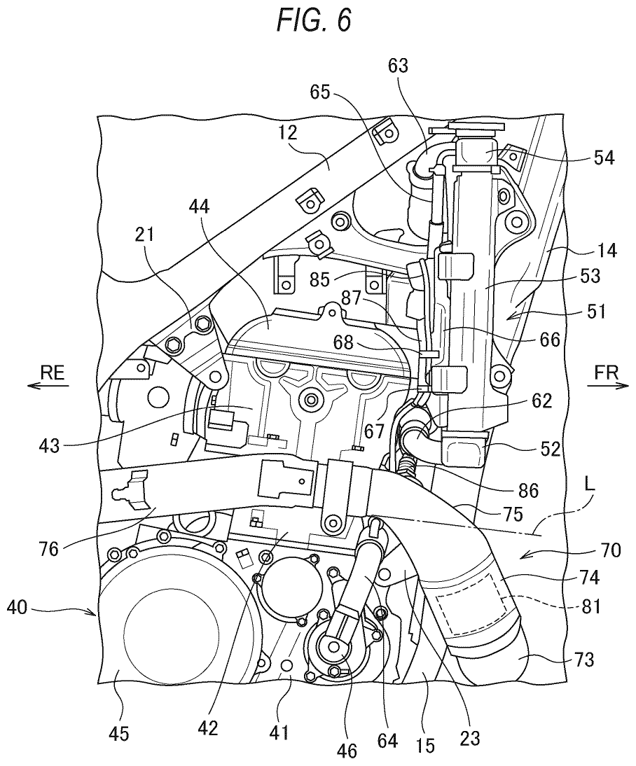

The layout of the second oxygen sensor will be described in detail with reference to FIGS. 5 and 6. FIG. 5 is a front view of a periphery of the second oxygen sensor according to the present embodiment. FIG. 6 is a right side view of the periphery of the second oxygen sensor according to the present embodiment. Note that in FIG. 5, the right radiator is indicated by a two-dot chain line.

As shown in FIG. 5, the right radiator 51 and the left radiator 55 are attached to the down frame 14 via radiator mounts 24. The exhaust pipe 70 passes below the right radiator 51. The second oxygen sensor 86 is attached to the exhaust pipe 70 (diameter-reduced pipe 75) on the lateral side of the cylinder 42. The second oxygen sensor 86 is covered by the right radiator 51 from the front side. More specifically, the base end side of the second oxygen sensor 86 is covered by the right inlet tank 52 of the right radiator 51 from the front side. The second oxygen sensor 86 does not obstruct exhaust air from the right radiator 51, and the second oxygen sensor 86 is protected by the highly rigid tank.

A base end of the second oxygen sensor 86 faces inward in the vehicle width direction. The second oxygen sensor 86 overlaps the cylinder head 43 in a front view. By positioning the second oxygen sensor 86 inside the exhaust pipe 70, the risk of damage to the second oxygen sensor 86 is reduced. Especially, when the vehicle rolls over, the second oxygen sensor 86 is less likely to collide with the ground. Even in a case where the second oxygen sensor 86 is disposed at a relatively high position, the second oxygen sensor 86 is hidden in the exhaust pipe 70 and is therefore not easily noticeable. By positioning the primary catalyst 81 (see FIG. 6) below the right radiator 51 and the second oxygen sensor 86 behind the right radiator 51, the right radiator 51, the primary catalyst 81, and the second oxygen sensor 86 are close to each other, resulting in a compact vehicle.

As shown in FIG. 6, the right radiator 51 is provided in front of the cylinder head 43. The second oxygen sensor 86 is positioned between the cylinder head 43 and the right radiator 51 (right inlet tank 52), in a side view. The second oxygen sensor 86 is positioned in an empty space between the cylinder head 43 and the right radiator 51, so that an appropriate gap is provided between the second oxygen sensor 86 and peripheral components. As described above, the base end of the second oxygen sensor 86 is directed inward in the vehicle width direction, and the second oxygen sensor 86 fits into the gap between the cylinder head 43 and the right radiator 51, thereby preventing the second oxygen sensor 86 from being exposed to the outside and reducing the risk of damage.

The inlet hose 62 extends from the right inlet tank 52. The inlet hose 62 covers the second oxygen sensor 86 from the upper side. The second oxygen sensor 86 is protected by the inlet hose 62, thereby reducing the risk of damage. In this way, the second oxygen sensor 86 is covered by the right inlet tank 52 from the front side, covered by the cylinder head 43 from the rear side, covered by the diameter-reduced pipe 75 from the right lateral side, and covered by the inlet hose 62 from the upper side. Therefore, the second oxygen sensor 86 is prevented from being exposed to the outside, and the second oxygen sensor 86 is protected by the peripheral components from flying objects such as flying stones.

In a side view, the diameter-reduced pipe 75 is divided into upper and lower parts by extending an extension line L of a lower edge of the downstream pipe 76 forward. The second oxygen sensor 86 is attached to an upper area of the diameter-reduced pipe 75. A second oxygen sensor 86 is not attached to a lower area of the diameter-reduced pipe 75. In the upper area of the diameter-reduced pipe 75, the diameter of the diameter-reduced pipe 75 is narrowed, thereby increasing a flow rate of the exhaust gas, improving exhaust gas exchange performance, and reducing the deviation of the flow of the exhaust gas. Therefore, the detection end of the second oxygen sensor 86 is positioned in the upper area of the diameter-reduced pipe 75, thereby improving the detection accuracy.

As described above, according to the engine 40 of the present embodiment, the second oxygen sensor 86 is attached to the exhaust pipe 70 on the lateral side of the cylinder 42, so that the minimum ground clearance of the straddle-type vehicle 1 can be easily ensured. Even when the second oxygen sensor 86 is attached to the exhaust pipe 70, the second oxygen sensor 86 is covered by the right radiator 51 from the front side, so that the second oxygen sensor 86 is protected by the right radiator 51 and the risk of damage is reduced.

Note that in the present embodiment, the exhaust pipe extends downward from the cylinder head, and the exhaust pipe is largely curved in front of the crank case, and then extends rearward passing through the lateral side of the cylinder, but the exhaust pipe may extend rearward from the cylinder head passing through the lateral side of the cylinder. For example, the exhaust pipe may extend from the cylinder head toward a lateral side and then extend rearward passing through the lateral side of the cylinder.

In the present embodiment, an oxygen sensor is used as an example of an exhaust gas sensor, but the exhaust gas sensor may be any sensor capable of detecting average characteristics of the exhaust gas, and may be, for example, an exhaust temperature sensor that detects an exhaust temperature of the exhaust gas.

In the present embodiment, the second oxygen sensor serving as an exhaust gas sensor is attached to the diameter-reduced pipe, but the exhaust gas sensor may be attached to the exhaust pipe on the lateral side of the cylinder. For example, the exhaust gas sensor may be attached to the downstream pipe.

In the present embodiment, the first and second oxygen sensors serving as exhaust gas sensors are provided in the exhaust pipe, but it is sufficient that at least one exhaust gas sensor is provided in the exhaust pipe.

In the present embodiment, the exhaust pipe is provided with the primary catalyst case and the secondary catalyst case, but it is sufficient that the exhaust device is provided with at least one catalyst case.

In the present embodiment, the engine is provided with the right radiator and the left radiator as radiators, but the engine may be provided with a single radiator.

The exhaust pipe in the present embodiment may be a single pipe or a double pipe.

The engine of the present embodiment is not limited to being used in the off-road type straddle-type vehicle described above, and may be used in other types of straddle-type vehicles. Note that the straddle-type vehicle is not limited to a general vehicle in which a driver rides on a seat in a posture straddling the seat, and includes a scooter-type vehicle in which the driver rides on the seat without straddling the seat.

As described above, a first aspect is an engine (40) to be mounted on a straddle-type vehicle (1), the engine including: a cylinder (42) and a cylinder head (43) stacked on an upper portion of a crank case (41); an exhaust pipe (70) extending from the cylinder head and passing through a lateral side of the cylinder; an exhaust gas sensor (second oxygen sensor 86) attached to the exhaust pipe on the lateral side of the cylinder; and a radiator (right radiator 51) positioned in front of the cylinder head, in which the exhaust gas sensor is covered by the radiator from a front side. According to this configuration, the exhaust gas sensor is attached to the exhaust pipe on the lateral side of the cylinder, making it easier to ensure the minimum ground clearance of the straddle-type vehicle. Even in a case where the exhaust gas sensor is attached to the exhaust pipe, the exhaust gas sensor is covered from the front side by the radiator, so that the exhaust gas sensor is protected by the radiator, thereby reducing the risk of damage thereto.

In a second aspect, according to the first aspect, the radiator includes a radiator core (right radiator core 53) configured to radiate heat of cooling water into air, and tanks (right inlet tank 52, right outlet tank 54) located on both upper and lower sides of the radiator core, and the exhaust gas sensor is covered by the lower tank from a front side. According to this configuration, the exhaust gas sensor does not obstruct the exhaust air from the radiator, and the exhaust gas sensor can be protected by the lower tank with high rigidity.

In a third aspect, according to the first aspect and the second aspect, the exhaust gas sensor is positioned between the cylinder head and the radiator, in a side view. According to this configuration, the exhaust gas sensor is positioned in an empty space between the radiator and the cylinder head, so that an appropriate gap can be provided between the exhaust gas sensor and the peripheral components. By fitting the exhaust gas sensor into the gap, the exhaust gas sensor is prevented from being exposed to the outside, thereby reducing the risk of damage.

In a fourth aspect, according to any one aspect of the first aspect to the third aspect, a base end of the exhaust gas sensor is directed inward in a vehicle width direction, and the exhaust gas sensor overlaps the cylinder head in a front view. According to this configuration, the exhaust gas sensor is positioned inside the exhaust pipe, thereby reducing the risk of damage to the exhaust gas sensor. Especially, when the vehicle rolls over, the exhaust gas sensor is less likely to collide with the ground. Even if the exhaust gas sensor is disposed at a relatively high position, the exhaust gas sensor is hidden in the exhaust pipe and is therefore not easily noticeable.

In a fifth aspect, according to any one aspect of the first aspect to the fourth aspect, the exhaust pipe includes an accommodation portion (primary catalyst case 74) that accommodates a catalyst below the radiator, and a diameter-reduced portion (diameter-reduced pipe 75) whose diameter is reduced from the accommodation portion toward a downstream, and the diameter-reduced portion is curved, and the exhaust gas sensor is attached to a downstream side of the diameter-reduced portion. According to this configuration, the exhaust gas sensor is positioned at a downstream side of the diameter-reduced portion where the diameter is reduced, and even when the diameter-reduced portion is curved, the exhaust gas is not likely to hit a detection end of the exhaust gas sensor, so that the detection accuracy will not be impaired. By disposing the catalyst below the radiator, the radiator, the catalyst, and the exhaust gas sensor are close to each other, making the straddle-type vehicle compact.

In a sixth aspect, according to the second aspect, a cooling water hose (inlet hose 62) extends from the lower tank, and the exhaust gas sensor is covered by the hose from above. According to this configuration, the exhaust gas sensor is covered by the cooling water hose from above, and the exhaust gas sensor is protected by the hose, thereby reducing the risk of damage.

In a seventh aspect, according to the second aspect, the radiator includes a shroud (66) that covers a back surface of the radiator core, and a lead wire (second lead wire 87) is held by the shroud, the lead wire extending from a base end of the exhaust gas sensor. According to this configuration, even in a case where the exhaust gas sensor disposed on the lateral side of the cylinder, the lead wire is held by the shroud, thereby making it possible to prevent vibration of the lead wire.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An engine to be mounted on a straddle-type vehicle, the engine comprising:
a cylinder and a cylinder head stacked on an upper portion of a crank case;
an exhaust pipe extending from the cylinder head and passing through a lateral side of the cylinder;
an exhaust gas sensor attached to the exhaust pipe, on the lateral side of the cylinder; and
a radiator positioned in front of the cylinder head,
wherein the exhaust gas sensor is covered by the radiator from a front side.

2. The engine according to claim 1,
wherein the radiator includes:
a radiator core configured to radiate heat of cooling water into air; and
tanks located on both upper and lower sides of the radiator core, and
the exhaust gas sensor is covered by the lower tank from a front side.

3. The engine according to claim 1,
wherein the exhaust gas sensor is positioned between the cylinder head and the radiator, in a side view.

4. The engine according to claim 1,
wherein a base end of the exhaust gas sensor is directed inward in a vehicle width direction, and
the exhaust gas sensor overlaps the cylinder head, in a front view.

5. The engine according to claim 1,
wherein the exhaust pipe includes:
an accommodation portion that accommodates a catalyst, below the radiator, and
a diameter-reduced portion whose diameter is reduced from the accommodation portion toward a downstream, and
the diameter-reduced portion is curved, and
the exhaust gas sensor is attached to a downstream side of the diameter-reduced portion.

6. The engine according to claim 2,
wherein a cooling water hose extends from the lower tank, and
the exhaust gas sensor is covered by the cooling water hose from above.

7. The engine according to claim 2,
wherein the radiator includes a shroud that covers a back surface of the radiator core, and
a lead wire is held by the shroud, the lead wire extending from a base end of the exhaust gas sensor.
